(19) United States
(12) Patent Application Publication
(10) Pub. No.: US 2022/0092982 A1
(43) Pub. Date: Mar. 24, 2022

(54) METHOD, COMPUTER PROGRAM AND APPARATUS FOR PROVIDING HAZARD INFORMATION

(71) Applicant: VOLKSWAGEN AKTIENGESELLSCHAFT, Wolfsburg (DE)

(72) Inventor: Viktor BADER, Wolfsburg (DE)

(21) Appl. No.: 17/480,760

(22) Filed: Sep. 21, 2021

(30) Foreign Application Priority Data
Sep. 24, 2020 (DE) 10 2020 212 032.3

(51) Int. Cl. G08G 1/16; B60Q 9/00; G08G 1/005; G08G 1/01; H04W 4/46; H04L 29/08; G08G 1/0967

(52) U.S. Cl. CPC G08G 1/164; B60Q 9/008; G08G 1/005; G08G 1/096791; G08G 1/0116; H04W 4/46; H04L 67/12; G08G 1/0112

(57) ABSTRACT

A method, apparatus, and computer for providing hazard information to a road user. The method includes detecting a potential hazard situation for the road user based on sensor data of an environment sensor system of a transportation vehicle; determining hazard information to be transmitted in relation to the hazard situation, wherein the hazard information to be transmitted includes information on a trajectory for the road user; and transmitting the hazard information to the road user by light-based data transmission.

### PRIORITY CLAIM

This patent application claims priority to German Patent Application No. 10 2020 212 032.3, filed 24 Sep. 2020, the disclosure of which is incorporated herein by reference in its entirety.

### SUMMARY

Illustrative embodiments relate to a method, a computer program having instructions, and an apparatus for providing hazard information to a road user. Illustrative embodiments further relate to a transportation vehicle in which a disclosed method or a disclosed apparatus is used.

### BRIEF DESCRIPTION OF THE DRAWINGS

Disclosed embodiments are described in more detail below with reference to the drawings, in which:

FIG. 1 shows a schematic view of a method for providing hazard information for a road user;

FIG. 2 shows a first exemplary embodiment of an apparatus for providing hazard information for a road user;

FIG. 3 shows a second exemplary embodiment of an apparatus for providing hazard information for a road user;

FIG. 4 shows a schematic view of a transportation vehicle in which a disclosed solution is realized;

FIG. 5 shows a traffic situation in which a road user is at risk of collision with an object;

FIG. 6 illustrates the transmission of hazard information to other road users;

FIG. 7 illustrates the transmission of hazard information to a person; and

FIG. 8 shows a schematic view of future trajectories after the transmission of the hazard information.

### DETAILED DESCRIPTION

Modern transportation vehicles are often equipped with a plurality of sensors to detect the environment of the transportation vehicles. Autonomous transportation vehicles in particular use environment sensors, such as cameras, laser scanners, lidar sensors, ultrasonic sensors, and radar sensors. In particular, for autonomous transportation vehicles, the aim is to achieve as closely as possible a complete 360° detection of the environment around the transportation vehicle.

Despite different mounting positions of the sensors on the transportation vehicle and the different technologies used, dynamic or static objects in the area around the transportation vehicle can impede the “vision” of the sensors and restrict the detection range. This effect is also referred to as masking.

For autonomously driven transportation vehicles, the environment sensors are the foundation of safe mobility. For all environment sensor technologies mentioned above, objects to be detected, e.g., pedestrians, must be in the field of view of the sensors of the autonomously driven transportation vehicle. However, the field of vision can be obscured by obstacles, e.g., by parked vehicles, so that static or moving objects are only detected late.

Against this background, patent DE 10 2017 218 932 A1 describes a method for evaluating a trajectory of a transportation vehicle. In the method, potential situations with masked areas are already known a priori. These situations are avoided or mitigated by defining a trajectory of the transportation vehicle in such a way that the areas where masking can occur are, if possible, deliberately circumvented.

In addition to the deliberate avoidance of masked areas, it is possible that in problematic situations a transportation vehicle may resort to using data from the environment sensors of another transportation vehicle or data from infrastructure facilities to determine a suitable trajectory.

For example, patent DE 10 2018 215 008 A1 describes a method for operating a transportation vehicle system of a first transportation vehicle. In the method, a first transportation vehicle analyzes its own driving situation and a driving situation of a second transportation vehicle with which the first transportation vehicle exchanges data. In addition, it takes into account the driving behavior or driving situation of a third transportation vehicle with which there is no communication link.

Such a Car-2-Car data exchange goes further than the detection of obstacles by the various sensors that are nowadays already fitted in most modern transportation vehicles. The Car-2-Car data exchange system can thus make driving considerably safer.

Applications based on Car-2-Car data exchange can use the WLAN standard 802.11p, for example. The possibilities for communication between networked transportation vehicles can be broadly divided into three categories: communication between a transportation vehicle and the environment (V2E: Vehicle to Environment), communication between a transportation vehicle and the driver (V2U: Vehicle to User) and communication between a transportation vehicle and a network (V2N: Vehicle to Network).

A number of technologies are available for communication between a transportation vehicle and the environment, the driver, or external networks. The WLAN standard 802.11p mentioned earlier is suitable for data exchange within a few hundred meters. The “LTE-V2X” standard defined a dedicated mobile radio protocol for automotive applications which is based on the LTE or 4G mobile radio technology. With the introduction of the new generation of mobile radio technology, 5G is also expected to supersede LTE-V2X. A hybrid solution is also conceivable, combining ad-hoc networks between transportation vehicles with communication via external networks such as LTE or 5G.

Another option for the communication is the use of visible light. VLC (Visible Light Communication) refers to a wireless transmission technology in which visible light is modulated with a data signal. This technique is also known as LiFi (Light Fidelity). For data transmission, there must be visual contact between a transmitter unit and a receiver unit. In transportation vehicles, for example, LED headlights or LED tail lights can be used (LED: light emitting diode). The transmission principle is simple. By using a modulator, a high-power LED is switched on and off very rapidly. These light pulses are detected by a photodiode in the receiver device and converted into electrical pulses as zeros and ones. The modulation takes place so fast that the human eye does not perceive any flickering of the light. Bi-directional transmission is also possible.

In this context, patent DE 10 2018 131 930 A1 describes a system for implementing an anti-collision mechanism. A guidance transportation vehicle comprises sensors, the data from which allows it to detect a possible collision. If a possible collision is detected, a following transportation vehicle is informed of this by data transmission with visible light.

Patent CN 106059666 A describes a LiFi-based vehicle interaction system. A transportation vehicle transmits driving data using a LiFi chip mounted in the headlight. The transmitted data is received by a following or oncoming transportation vehicle. A control computer of the following or oncoming transportation vehicle analyzes and processes the driving information to obtain real-time information about the driving status of the other transportation vehicle. In this way, the control computer can take effective measures in good time to prevent transportation vehicle collisions or accidents involving rear-end collisions.

Patent DE 10 2016 209 552 A1 describes a method for warning about a pedestrian in an environment of a parked vehicle. In the method, an environment sensor signal representing the pedestrian is read in from a transportation vehicle environment sensor and, by using the environment sensor signal, a warning signal is issued to another transportation vehicle to warn it about the pedestrian.

DE 10 2019 001 092 A1 describes a method for operating a driver assistance system of a transportation vehicle, which comprises a communication device for vehicle-to-vehicle communication with a second transportation vehicle and a sensor device for capturing a region surrounding the transportation vehicle. In the process, an image of the surrounding region is created based on the capture of the surrounding region by the sensor device, and objects and their movement relative to the first transportation vehicle are identified in the image. Internal transmission data is then created, which includes the identified objects and their movement, and transmitted to the second transportation vehicle.

Disclosed embodiments provide improved solutions for providing hazard information to a road user.

This is achieved by the disclosed method, by the disclosed computer program having instructions, and by the disclosed apparatus.

According to a first disclosed embodiment, a method for providing hazard information for a road user comprises detecting a potential hazard situation for the road user based on sensor data of an environment sensor of a transportation vehicle; determining hazard information to be transmitted in relation to the hazard situation, wherein the hazard information to be transmitted includes information on a trajectory for the road user; and transmitting the hazard information to the road user by light-based data transmission.

According to a further disclosed embodiment, a computer program comprises instructions which, when executed by a computer, cause the computer to execute the method to provide hazard information for a road user detecting a potential hazard situation for the road user based on the sensor data of an environment sensor of a transportation vehicle; determining hazard information to be transmitted in relation to the hazard situation, wherein the hazard information to be transmitted includes information on a trajectory for the road user; and transmitting the hazard information to the road user by light-based data transmission.

The term computer used here is to be interpreted broadly. In particular, it also comprises control units, embedded systems, and other processor-based data processing devices.

For example, the computer program may be made available for electronic retrieval, or may be stored on a computer-readable storage medium.

According to a further disclosed embodiment, an apparatus for providing hazard information for a road user comprises an evaluation unit for detecting a potential hazard situation for the road user based on sensor data of an environment sensor system of a transportation vehicle; a computing unit for determining hazard information to be transmitted in relation to the hazard situation, wherein the hazard information to be transmitted includes information on a trajectory for the road user; and a transmission unit for transmitting the hazard information to the road user by light-based data transmission.

The disclosed solution is based on a first transportation vehicle which may be configured to carry out, by using a dedicated environment sensor system, a processing chain comprising a series of processing operations including capturing an environment of the first transportation vehicle, detecting objects in the captured environment, mapping the environment, calculating a probability of collision of the first transportation vehicle with objects detected in the environment, as well as trajectory planning and an open-loop or closed-loop control of a longitudinal and transverse guidance of the first transportation vehicle. In addition, in the disclosed solution the first transportation vehicle is configured to detect a possible hazard situation for another road user using its own environment sensor system. These can be hazard situations that cannot be detected by the other road user, or at least not yet detected by the other road user itself, e.g., because the vision for the latter's environment sensor system is masked. In this way, the other road user can be informed by the transportation vehicle at an early stage and react accordingly in a pre-emptive way, e.g., to slow down the movement or pre-emptively initiate an evasive maneuver.

According to the disclosed embodiments, the hazard information to be transmitted includes information on a trajectory for the road user. The transportation vehicle can transmit information for planning the trajectory to the road user directly or make specifications for trajectories, or even perform direct open-loop or closed-loop control of the longitudinal and transverse guidance of the road user. This allows an even faster response to potential hazard situations.

The information exchange takes place by light-based data transmission, i.e., using VLC/LiFi technology. Although this requires a visual contact between the communication partners, it allows them to react as quickly as possible to modified situations without first having to connect data networks between them. This transmission path cannot be subject to interference by electromagnetic waves, for example. In addition, very high data rates can be achieved.

Networked transportation vehicles are becoming an increasingly attractive target for cyber attacks. If an attacker succeeds in penetrating the computer system of a transportation vehicle, they could issue malicious commands within the on-board network, for example. Or, by interfering with the network, for example, using a denial of service attack, the attacker could prevent a transportation vehicle from receiving warning signals from other road users. As a consequence, this could cause an accident. Due to the large number of possible attack methods, it is very important to implement communication between transportation vehicles as securely as possible.

One benefit of communication between transportation vehicle by visible light compared to the above-mentioned data transmission routes using WLAN or mobile radio is that a higher level of security is achieved. By using different environment sensors of a transportation vehicle, such as cameras, laser scanners, radar sensors or lidar sensors, it can be ensured, for example, that a data transmission by light emanates uniquely from a specific other transportation vehicle.

According to at least one exemplary embodiment, the potential hazard situation for the road user is a potential collision with an object. It is beneficial to detect potential hazard situations in conjunction with other road users, e.g., pedestrians or cyclists. However, potential hazard situations arising from animals or other moving objects can also be detected pre-emptively. For example, it may be the case that a moving pedestrian cannot be detected by the road user because the vision for its environment sensor system is masked. However, the pedestrian can be detected by the environment sensor system of the transportation vehicle. If it is then determined that the pedestrian might cross the trajectory of the road user, the traffic user is informed in good time and can react accordingly.

The use of VLC/LiFi technology is also beneficial in this context because for the detection of possible collisions between the road user and another object there should be a visual contact with the road user and the object anyway, to be able to predict the paths of the road user and the object in the best possible way, and also to take into account road users or objects that cannot be detected via known Car2Car communication paths.

According to at least one disclosed embodiment, a probability of collision is ascertained and hazard information is determined and transmitted to the road user only if the probability of collision exceeds a threshold value. In connection with moving persons, the future movement of these persons cannot usually be unambiguously predicted. It is therefore generally practical to determine a probability of collision. This can then be used as a basis for the further procedure. If the probability of collision with the road user is only small, the transmission of hazard information to the road user can be omitted. Optionally, a threshold value for the collision probability is defined, the desired hazard information being determined and transmitted when this threshold is exceeded. In this way, the data exchange between the transportation vehicle and other road users is limited to a manageable amount of data. Alternatively, it is also possible that the determination of a collision probability is carried out by the road user affected by the possible collision itself. In this case, the data of the environment sensors of the transportation vehicle may be provided to the road user.

In a further exemplary embodiment, the determination of the collision probability of the road user with an object located outside a field of view of its environment sensors can also be carried out on an external server. To this end, the latter evaluates the data of the environment sensors of all involved transportation vehicle or road users within a certain radius with regard to collision probabilities, possibly limited to specific traffic situations. If a threshold value for a collision probability is exceeded, the transportation vehicle or road users involved are informed where possible.

The collision probabilities can also be determined, in particular, using an artificial intelligence algorithm that determines the violation of a threshold for a collision probability for road users for a given traffic situation in a given environment. The algorithm can then inform as many as possible of the transportation vehicle or road users involved, or even specify the safest possible trajectories or driving maneuvers for all accessible transportation vehicle or road users. For example, an accident black spot, such as an intersection with poor visibility, can be networked with the road users in a specific radius using artificial intelligence by centrally processing the data of all available environment sensors and evaluating them with regard to collision probabilities. If necessary, environment sensors, e.g., cameras, that are permanently positioned at the hazard black spot can also be included in an overall assessment.

According to at least one disclosed embodiment, the hazard information to be transmitted includes information about the object. Optionally, using its own environment sensors, the transportation vehicle may carry out a processing chain with regard to the road user, comprising a series of processing operations: capturing an environment of the road user, detecting objects in the captured environment of the road user, mapping the environment, and possibly calculating a probability of collision of the first transportation vehicle with objects detected in the environment. This information about the object is then passed on to the road user. The road user can then use this additional information from the transportation vehicle to plan the trajectory and to carry out open-loop or closed-loop control of the longitudinal and transverse guidance.

According to at least one disclosed embodiment, the road user is a second transportation vehicle. The use of the disclosed solution is beneficial for warning another transportation vehicle, which in turn can take appropriate measures to avoid a collision using available assistance functions. If no suitable assistance functions are available, at least one warning can be issued to an operator of the transportation vehicle.

However, in principle the disclosed solution is also suitable for warning pedestrians or cyclists about potential hazard situations. For example, pedestrians or cyclists can wear smart clothing or wearables that can capture VLC data and, if necessary, pass on signals to the user of the clothing or wearable, e.g., a vibration signal as an emergency signal.

According to at least one disclosed embodiment, information is also transmitted to other road users by light-based data transmission. Optionally, the information about a detected potential hazard situation is transmitted to as many road users at risk as possible, so that they can take measures as early as possible and prevent possible collisions or hazard situations pre-emptively as necessary. In addition, other road users may also receive relevant information from the transportation vehicle, in particular, those road users for whom there is no risk of collision to themselves, but who may have to react to possible braking or evasive maneuvers by the road user affected by the hazard situation. These road users may also need to perform braking or steering maneuvers. By informing these road users in good time, the maximum safety of all road users can be achieved if a secure and very fast data exchange is possible in each case.

A disclosed method or an exemplary apparatus will beneficially be used in a transportation vehicle. The transportation vehicle can be, e.g., a passenger car or a commercial vehicle, but also a rail vehicle or an aircraft, e.g., a Volocopter, etc.

For a better understanding of the principles of the disclosure, exemplary embodiments are described in more detail below by reference to the figures. It goes without saying that the disclosure is not limited to these exemplary embodiments and that the described features can also be combined or modified without departing from the scope of protection of the disclosure, as it is defined in the appended claims.

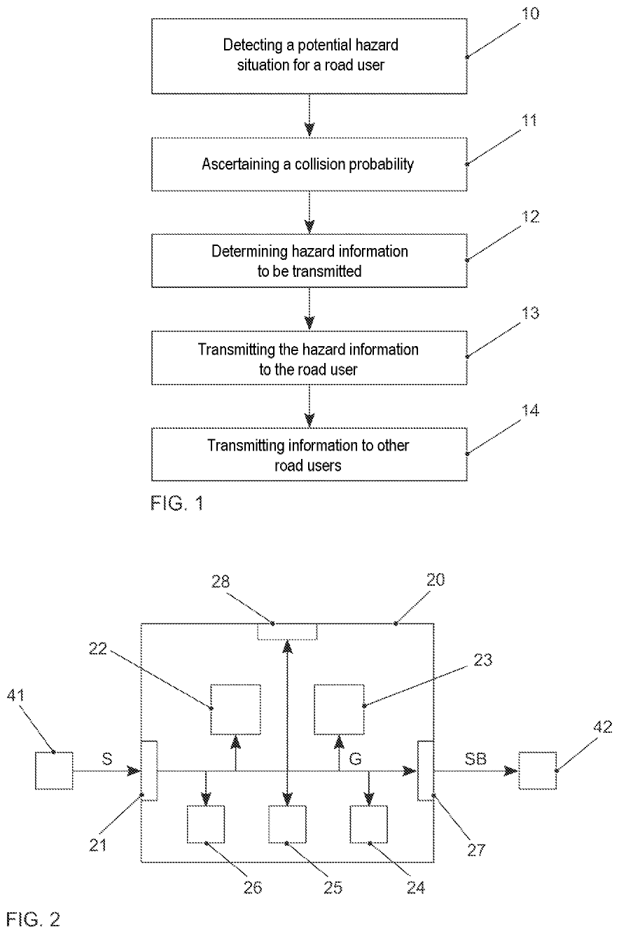

FIG. 1 shows a schematic view of a method for providing hazard information for a road user. In a first operation, a potential hazard situation for the road user is detected by sensor data from an environment sensor system of a transportation vehicle 10, e.g., a potential collision with an object. In this context, a collision probability can also be ascertained 11. In addition, hazard information to be transmitted with regard to the hazard situation is determined 12. These are then transmitted 13 to the road user by light-based data transmission. The road user can be, in particular, a second transportation vehicle. In addition, information can also be transmitted 14 to other road users by light-based data transmission. The determination and transmission of hazard information can be linked to the condition that the collision probability exceeds a threshold value. The hazard information may include, for example, information about the object or about a trajectory for the road user.

FIG. 2 shows a simplified schematic representation of a first exemplary embodiment of an apparatus 20 for providing hazard information for a road user. The apparatus 20 has an input 21, via which an evaluation unit 22 receives sensor data S of an environment sensor system 41 of a transportation vehicle. The evaluation unit 22 is configured to detect a potential hazard situation for the road user, e.g., a potential collision with an object, using the sensor data S. In this context, a collision probability can also be ascertained using the evaluation unit 22. A computing unit 23 then determines the hazard information G to be transmitted in relation to the hazard situation. Finally, a transmission unit 24 transmits the hazard information G to the road user by light-based data transmission. For this purpose, appropriate control commands SB can be issued to a light-based data transmission unit 42 via an output 27 of the apparatus. The road user can be, in particular, a second transportation vehicle. In addition, information can also be transmitted to other road users by light-based data transmission. The determination and transmission of hazard information can be linked to the condition that the collision probability exceeds a threshold value. The hazard information may include, for example, information about the object or about a trajectory for the road user.

The evaluation unit 22, the computing unit 23 and the transmission unit 24 can be controlled by a control unit 25. Via a user interface 28, settings of the evaluation unit 22, the computing unit 23, the transmission unit 24 or the control unit 25 can be changed as appropriate. The data accruing in the apparatus 20 can if necessary be stored in the memory 26, for example, for later evaluation or for use by the components of the apparatus 20. The evaluation unit 22, the computing unit 23, the transmission unit 24 and the control unit 25 can be implemented as dedicated hardware, for example, as integrated circuits. However, they can of course also be partially or completely combined, or implemented as software that runs on a suitable processor, for example, on a GPU or a CPU. The input 21 and the output 27 can be implemented as separate interfaces or as a combined bi-directional interface.

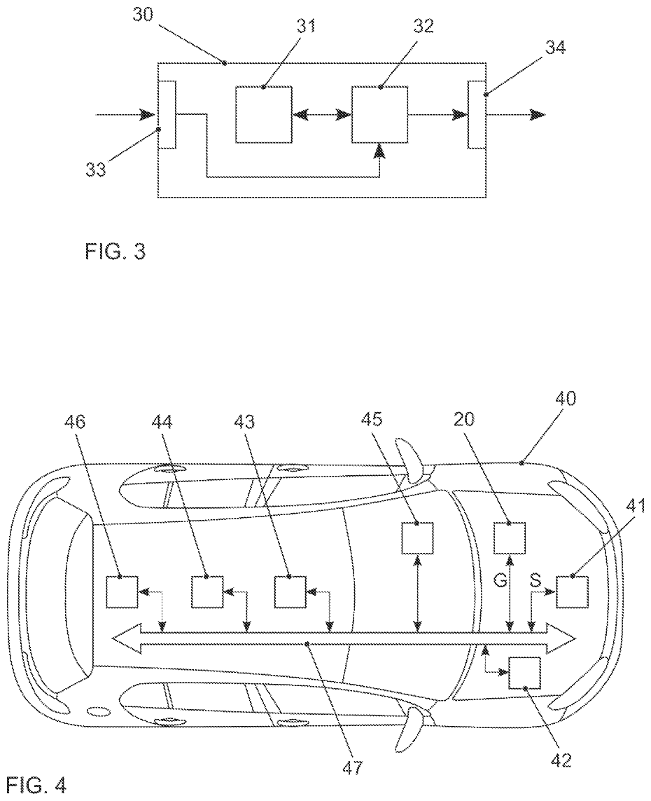

FIG. 3 shows a simplified schematic representation of a second exemplary embodiment of an apparatus 30 for providing hazard information for a road user. The apparatus 30 comprises a processor 32 and a memory 31. For example, the apparatus 30 is a computer or a control device. Instructions are stored in the memory 31, which when executed by the processor 32 cause the apparatus 30 to execute the operations according to one of the methods described. The instructions stored in the memory 31 thus embody a program that can be executed by the processor 32, which implements the disclosed method. The apparatus 30 has an input 33 for receiving information, for example, Information of a sensor system of the transportation vehicle. Data generated by the processor 32 is provided via an output 34. In addition, it can be stored in the memory 31. The input 33 and the output 34 can be combined to form a bi-directional interface.

The processor 32 can comprise one or more processor units, for example, microprocessors, digital signal processors, or combinations of these.

The memories 26, 31 of the embodiments described can have both volatile and non-volatile memory areas and comprise a wide variety of storage devices and storage media, such as hard drives, optical storage media or semiconductor memories.

FIG. 4 shows a schematic view of a transportation vehicle 40 in which a disclosed solution is realized. The transportation vehicle has an environment sensor system 41 which can be used to capture sensor data S relating to an environment of the transportation vehicle. The environment sensor system 41 can comprise cameras, laser scanners, radar sensors, lidar sensors, or ultrasonic sensors. An exemplary apparatus 20 for providing hazard information G evaluates the sensor data S and, if necessary, initiates the transmission of hazard information G to another road user by a light-based data transmission unit 42. This can be integrated into, e.g., LED headlights or LED tail lights of the transportation vehicle and use VLC/LiFi technology. Other components of the transportation vehicle are a navigation system 43, a radio-based data transmission unit 44, and a range of assistance systems 45, an example of one of which is shown. GPS data can be provided by the navigation system 43 if required. The radio-based data transmission unit 44 can be used to establish a connection to service providers, to infrastructure facilities or, if necessary, to other transportation vehicles. A memory 46 is provided for storing data. The data exchange between the various components of the transportation vehicle is carried out via a network 47.

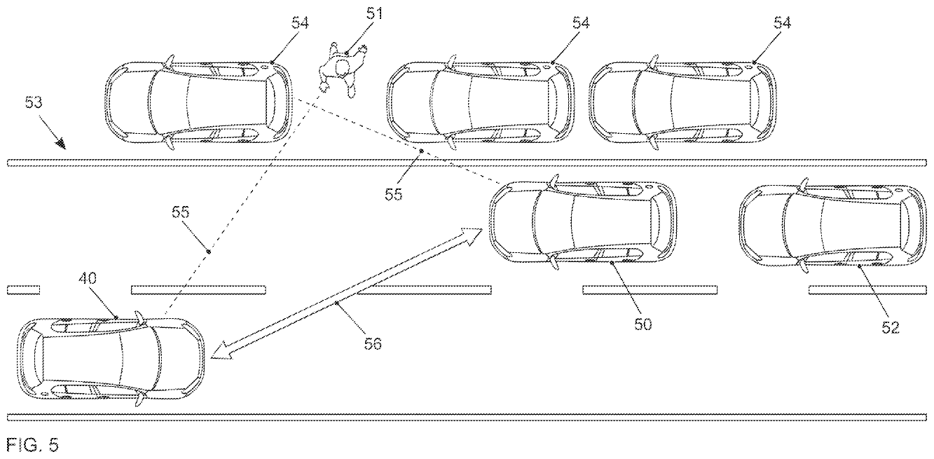

In the following, an example of a disclosed solution is described based on FIG. 5 to FIG. 8.

FIG. 5 shows a traffic situation in which a road user 50 is at risk of a collision with an object 51. In this example, the object 51 is a person and the road user 50 is a transportation vehicle. The road user 50 is driving past a series of parked vehicles on a road 53. These represent obstacles 54 for an environment sensor system of the road user 50, so that the field of view 55 of the environment sensors is restricted. The road user 50 is followed by another road user 52, which in this example is also a transportation vehicle. In the opposite direction, a transportation vehicle 40, in this case also a transportation vehicle, the environment sensor system of which is able to detect the object 51 due to the less restricted field of view 55 with respect to the object 51. The transportation vehicle 40 detects an impending collision between the road user 50 and the object 51. The relevant hazard information relating to the hazard situation is then transmitted by the transportation vehicle 40 via a VLC communication link 56 to the road user 50, which can then take appropriate measures to avoid a collision. The determination and transmission of hazard information can be linked to the condition that an ascertained collision probability exceeds a threshold value.

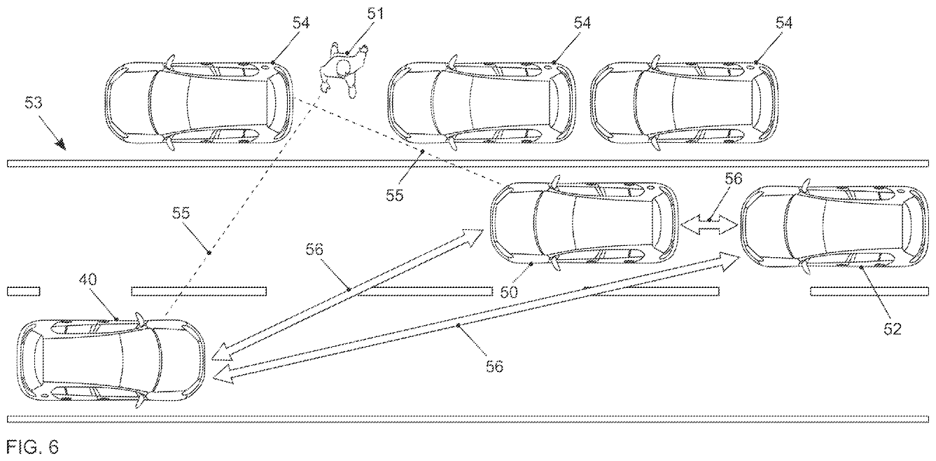

FIG. 6 illustrates the transmission of hazard information to other road users 52. The other road user 52 following the road user 50 is not itself directly threatened by a collision with the object 51. Nevertheless, hazard information can also be transmitted to this other road user 52 via a VLC communication link 56, e.g., by the transportation vehicle 40 or by the directly affected road user 50. By informing the other road user 52 in good time, the risk associated with the hazardous situation can be minimized if a secure and very fast data exchange is possible. Here again, the determination and transmission of hazard information can also be linked to the condition that an ascertained collision probability exceeds a threshold value.

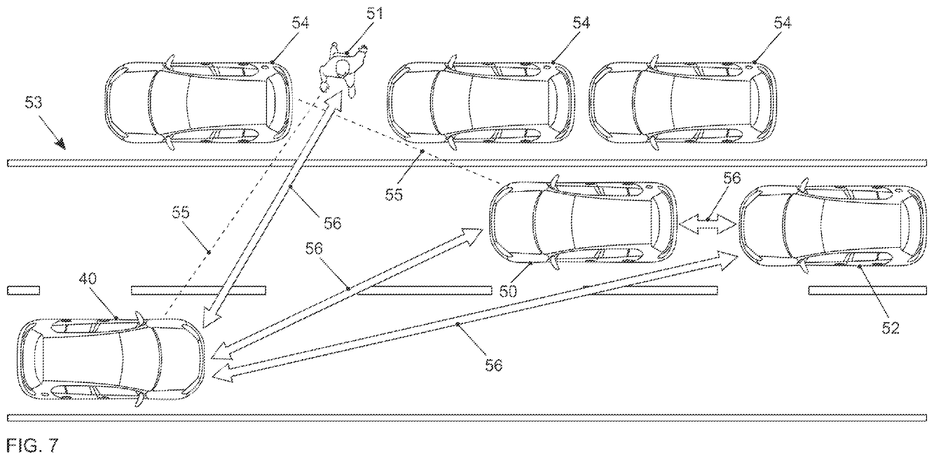

FIG. 7 illustrates the transmission of hazard information to a person. In at least one disclosed embodiment, the object 51 at risk of a collision, in this case the person, is also informed if a collision is imminent. This in turn can be made dependent on an ascertained collision probability exceeding a threshold value. For example, the pedestrian can wear smart clothing or a wearable that can capture VLC data and, if necessary, generate a warning signal, such as a vibration signal.

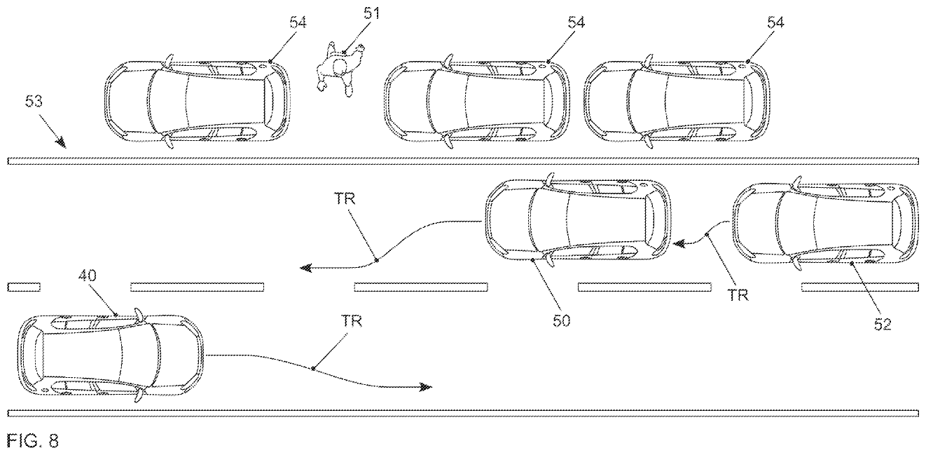

FIG. 8 shows a schematic view of future trajectories TR after the transmission of the hazard information. The transportation vehicle 40, which detected the potential hazard situation and informed the other road users 50, 52 accordingly, deviates a little to the right in the direction of travel to create space for the evasive maneuvers of the other road users 50, 52. The other road users 50, 52 deviate slightly further to the left in the direction of travel and, if necessary, additionally apply their brakes so that a collision with the person is avoided as far as possible if the person should run onto the road 53.

### LIST OF REFERENCE SIGNS

10 detecting a potential hazard situation for a road user
11 ascertaining a probability of collision
12 determining hazard information to be transmitted
13 transmitting the hazard information to the road user
14 transmitting information to other road users
20 apparatus
21 input
22 evaluation unit
23 computing unit
24 transmission unit
25 control unit
26 memory
27 output
28 user interface
30 apparatus
31 memory
32 processor
33 input
34 output
40 transportation vehicle
41 environment sensor system
42 light-based data transmission unit
43 navigation system
44 radio-based data transmission unit
45 assistance systems
46 memory
47 network
50 road user
51 object
52 road user
53 road
54 obstacle
55 field of view
56 VLC communication connection
G hazard information
S sensor data
SB control command
TR trajectory

1. An apparatus for providing hazard information for a road user, the apparatus comprising:
an evaluation unit for detecting a potential hazard situation for the road user based on sensor data of an environment sensor system of a transportation vehicle;
a computing unit for determining hazard information to be transmitted in relation to the hazard situation, wherein the hazard information to be transmitted includes information on a trajectory for the road user; and
a transmission unit for transmitting the hazard information to the road user by light-based data transmission.

2. A transportation vehicle comprising the apparatus of claim 1 for providing hazard information for a road user.

3. The apparatus of claim 1, wherein the potential hazard situation for the road user is a potential collision with an object.

4. The apparatus of claim 3, wherein a probability of collision is ascertained and hazard information is determined and transmitted to the road user only in response to the probability of collision exceeding a threshold value.

5. The apparatus of claim 3, wherein the hazard information to be transmitted includes information on the object.

6. The apparatus of claim 1, wherein the information on the trajectory for the road user includes specifications for trajectories, or controls a longitudinal and transverse guidance of the road user.

7. The apparatus of claim 1, wherein the road user is a second transportation vehicle.

8. The apparatus of claim 1, wherein information is also transmitted to other road users by light-based data transmission.

9. A method for providing hazard information to a road user, the method comprising:
detecting a potential hazard situation for the road user based on sensor data of an environment sensor system of a transportation vehicle;
determining hazard information to be transmitted in relation to the hazard situation, wherein the hazard information to be transmitted includes information on a trajectory for the road user; and
transmitting the hazard information to the road user by light-based data transmission.

10. The method of claim 9, wherein the potential hazard situation for the road user is a potential collision with an object.

11. The method of claim 9, wherein a probability of collision is ascertained and hazard information is determined and transmitted to the road user only in response to the probability of collision exceeding a threshold value.

12. The method of claim 9, wherein the hazard information to be transmitted includes information on the object.

13. The method of claim 9, wherein the information on the trajectory for the road user includes specifications for trajectories, or controls a longitudinal and transverse guidance of the road user.

14. The method of claim 9, wherein the road user is a second transportation vehicle.

15. The method of claim 9, wherein information is also transmitted to other road users by light-based data transmission.

16. A non-transitory computer readable medium including a computer program having instructions which, when executed by a computer, cause the computer to execute operations for providing hazard information for a road user, the operations comprising:
detecting a potential hazard situation for the road user based on sensor data of an environment sensor system of a transportation vehicle;
determining hazard information to be transmitted in relation to the hazard situation, wherein the hazard information to be transmitted includes information on a trajectory for the road user; and
transmitting the hazard information to the road user by light-based data transmission.

17. The non-transitory computer readable medium of claim 16, wherein the potential hazard situation for the road user is a potential collision with an object.

18. The non-transitory computer readable medium of claim 17, wherein a probability of collision is ascertained and hazard information is determined and transmitted to the road user only in response to the probability of collision exceeding a threshold value.

19. The non-transitory computer readable medium of claim 17, wherein the hazard information to be transmitted includes information on the object.

20. The non-transitory computer readable medium of claim 16, wherein the information on the trajectory for the road user includes specifications for trajectories, or controls a longitudinal and transverse guidance of the road user.

21. The non-transitory computer readable medium of claim 16, wherein the road user is a second transportation vehicle.

22. The non-transitory computer readable medium of claim 16, wherein information is also transmitted to other road users by light-based data transmission.
